(19) United States
(12) Patent Application Publication
(10) Pub. No.: US 2012/0277974 A1
(43) Pub. Date: Nov. 1, 2012

(54) CURVE OF MAXIMUM ALLOWABLE ENGINE TORQUE FOR CONTROLLING A COMBUSTION ENGINE

(75) Inventors: Anders Hedman, Marstrand (SE); Lars Sundin, Malmo (SE)

(73) Assignee: Volvo Lastvagnar AB, Goteborg (SE)

(21) Appl. No.: 13/395,300

(22) PCT Filed: Sep. 11, 2009
(86) PCT No.: PCT/SE09/00404

§ 371 Date: Mar. 30, 2012

(51) Int. Cl. F02D 28/00

(52) U.S. Cl. 701/102

(57) ABSTRACT

A curve of maximum allowable engine torque as a function of engine rotational speed for controlling a combustion engine is provided, where a combustion engine control unit is arranged to control output torque and engine rotational speed as not to exceed the curve, and where the curve is defined by a torque build up range (n0 to ni), constant power range (n2 to 113) and a torque ramp down range (n3 to n4). The torque ramp down range is defined so that the engine rotational speed at high engine power is reduced, while high engine rotational speeds are allowed at low engine power.

### BACKGROUND AND SUMMARY

The present invention relates to a curve of maximum allowable engine torque as a function of engine rotational speed for controlling a combustion engine of heavy road vehicles, and more particularly to relations of torque and speed for combustion engines mated to power-interrupting transmissions.

A typical known curve 1 of maximum engine torque as a function of the engine rotational speed for a contemporary heavy truck combustion engine of turbo-charged diesel type is shown in FIG. 1.

Between rotational speeds n0 (idle speed) and ni, the torque is being built up, limited by the turbo-charging system, in a torque build up range of said curve. Between n1 and n2, the torque is constant or fairly constant, a controlled maximum value in order to limit the load on the rest of the powertrain (clutch, transmission, driven axles). This constant torque range is then followed by a constant power range (n2 to n3) where the power is close to the maximum power of the engine. With increased-engine rotational speed the maximum engine torque gradually drops during the constant power range. Finally, the torque is ramped down to zero level from n3 to n4, and engine power will also decrease to zero.

In general, a large overall speed range of the engine (n0 to n4) is of advantage for the driveability of a vehicle. That makes gear-shifts less critical. However, the efficiency of the engine, and hence the fuel consumption of the vehicle, would benefit of a smaller overall speed range. In FIG. 1, a high speed area and a high torque area are highlighted. Normally, the engine efficiency is relatively bad in the high speed area and good in the high torque area. By reducing the high speed area, the average efficiency of the engine will improve.

In the development of heavy road vehicles, such as heavy trucks and buses, it is desirable to reduce the fuel consumption while complying with the mandatory regulations on emissions. In the past, improved efficiency of the engine has been achieved to a large extent by lowering the rotational speed range of the engine, with a corresponding increase in the torque range. Further developments in the same way would be difficult without sacrificing the driveability of the vehicle, especially if the transmission is of a power-interrupting type.

In alternative known solutions improved engine efficiency can be achieved without reducing the speed range of the engine, e.g., by means of using multiple supercharging equipment. That would add costs to the engine, however, which is less appealing.

A transmission with more closely spaced gear ratios would make the driveability less sensitive to a reduced engine speed range. On the other hand, such a transmission would require more gears, making it more complex, heavy and costly compared to a transmission with normally spaced gear ratios. Furthermore, the potential to reduce the engine speed range would be small.

Most of the driveability issues are caused by the interruption in the power supply to the driven wheels that is inherent in a conventional, power-interrupting transmission. For instance, in an up-hill grade, the vehicle will lose speed at a gear shift. The engine speed range must then be correspondingly larger than what would result from the change in gear ratio alone.

Another example would be at acceleration at low vehicle speed and weight. Acceptable driveability would in that case require multi-step gear shifts, e.g., from first into third gear, or from second into fifth gear. A reduced engine speed range may not allow that.

A powershifting transmission would offer a very good driveability, even with a reduced engine speed range. However, present powershifting transmissions are very expensive. They also have high power losses in operation, which counteracts ambitions to decrease the fuel consumption.

US2005/0145218 shows an example of a narrow peak torque curve combustion engine combined with a continuously variable transmission.

It is desirable to reduce the fuel consumption by decreasing the speeds of the engine while maintaining acceptable driveability and a low product cost.

According to an aspect of the present invention, a curve of maximum allowable engine torque as a function of engine rotational speed for controlling a combustion engine is provided. According to a first aspect of the invention, there is provided a curve of maximum allowable engine torque as a function of engine rotational speed for controlling -a combustion engine, where a combustion engine control unit is arranged to control output torque and engine rotational speed as not to exceed said curve, and where said curve is defined by at least a torque build up range (n0 to ni), constant power range (n2 to n3) and a torque ramp down range (n3 to n4). The inventive curve is characterized in that said torque ramp down range is defined so that the engine rotational speed at high engine power is reduced, while high engine rotational speeds are allowed at low engine power.

According to one embodiment of the curve according to the invention, said high engine power is defined as above 50% of the maximum engine power and low engine power is defined as below 50% of the maximum engine power.

According to another embodiment of the curve according to the invention, a difference between maximum engine rotational speeds at 50% and 75% of maximum engine power should be larger than 150 rpm.

According to a further embodiment of the curve according to the invention, the maximum engine rotational speed at 50% of maximum engine power should be less than 2300 rpm.

According to another embodiment of the curve, the maximum engine rotational speed at 50% of maximum engine power should be larger than 1.2 multiplied by the maximum engine rotational speed at 95% of maximum engine power.

According to another embodiment of the curve according to the invention, at maximum allowable engine rotational speed and 0% of maximum engine power the difference between said maximum allowable engine rotational speed and engine rotational speed at 50% of maximum engine power is larger than 100 rpm.

In further embodiments of the invention said combustion engine is mated to a power-interrupting automatic transmission and/or said combustion engine comprises a supercharging arrangement of the turbocompound-type.

### BRIEF DESCRIPTION OF THE DRAWING

The present invention will be described in greater detail below with reference to the accompanying drawing which, for the purpose of exemplification, shows further preferred embodiments of the invention and also the technical background, and in which:

FIG. 1 diagrammatically shows a curve of maximum engine torque according to known art.

FIG. 2 diagrammatically shows a curve of maximum engine torque according to an embodiment of the invention.

FIG. 3 diagrammatically shows a curve of maximum engine torque according to another embodiment of the invention.

FIG. 4 diagrammatically shows a curve of maximum engine torque according to another embodiment of the invention.

FIG. 5 shows the invention applied on a computer arrangement.

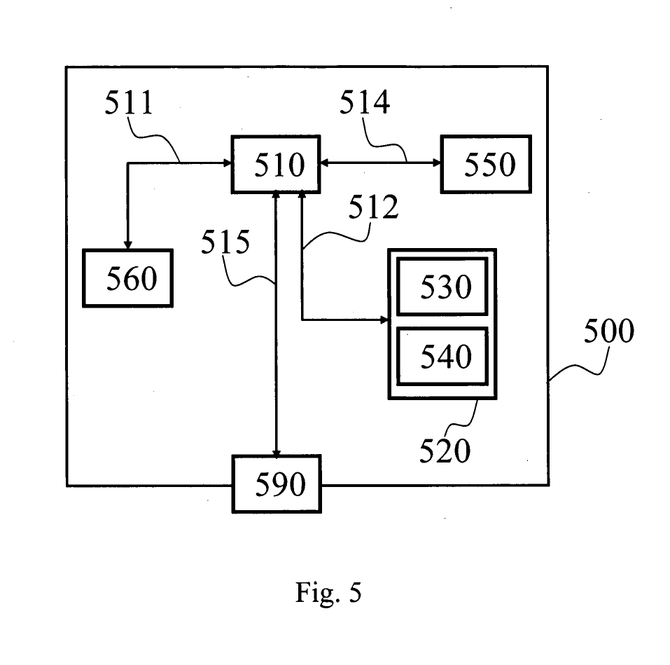

### DETAILED DESCRIPTION

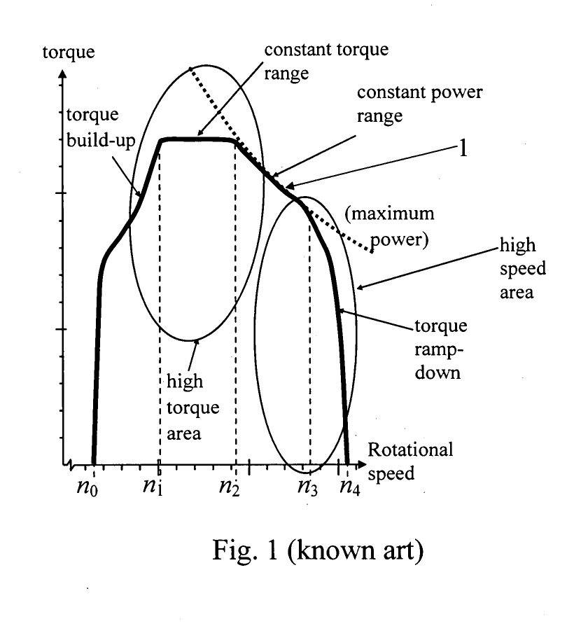

Returning to FIG. 1, reducing the speeds would be of advantage for the engine efficiency in two ways. Firstly, inefficient points of operation would not be used. Secondly, the engine can be optimised for, and become more efficient at, lower speeds. The supercharging system in particular would benefit from not having to operate at high speed—high power combinations.

Within limits, it would also be advantageous for the fuel consumption to increase the high torque area towards higher torques. A steeper torque build up would be technically possible to achieve, but for a number of reasons significant changes would be unfavourable. So, in order not to compromise the driveability at low vehicle speed and allow multi-step shifts, it is necessary that the engine can be operated at fairly high speeds when it is mated to a power-interrupting transmission. Fortunately, multi-step gear shifts at low vehicle speeds are in general associated with driving conditions that do not require very large engine power. Normally, less than half the maximum engine power is required.

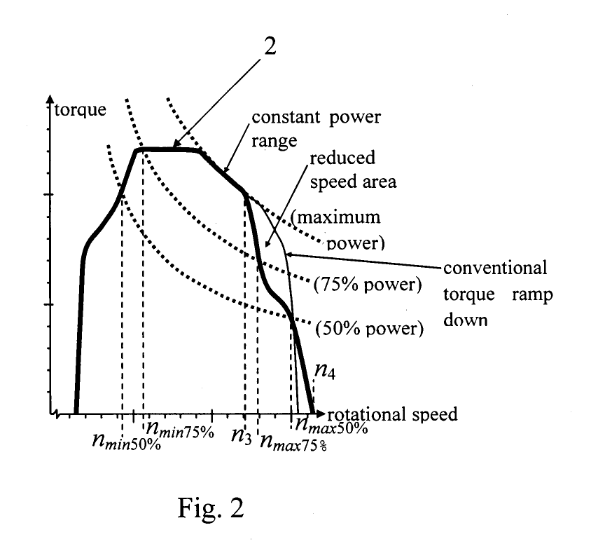

According to one embodiment of the invention (see FIG. 2) the engine speed at the torque ramp down at high power (above 50% of the maximum power) is reduced, while allowing fairly high engine speeds at low power (below 50% of the maximum power).

The torque curve in FIG. 2 still enables multi-step gear shifts at low vehicle speed and weight. The supercharging system is relieved from demanding high engine speed and power operation. Instead, it can be optimised to increase the efficiency in the remaining area of operation.

In order to make largest use of the modified torque ramp down, the reduced speed area should be made as large as possible. However, a start of the torque ramp down at too low engine speed (n3 in FIG. 2) would reduce the constant power range. That would have a negative impact on the vehicle, performance at driving conditions where high engine power is required. So, it is desirable to have a steep torque ramp down, from a not too small value of n3, to somewhere above the level of half maximum power. For a heavy road vehicle, that could be quantified as follows; the difference between the maximum speeds at 50% and 75% of maximum engine power (See FIG. 2; nmax 50% minus nmax75%) should be larger than 150 rpm. Moreover, in order for this low-speed design to be really effective and not too demanding for the supercharging system, the engine speeds should be limited, e.g., n max50% should be less than 2100 rpm.

Thus, a curve according to the invention is suitable for a supercharged combustion engine for heavy road vehicles. (15-100 tonnes) equipped with a power interrupting (stepped) transmission, and where according to one embodiment;

nmax50% minus nmax75%>150 rpm and nmax50%<2100 rp

In further embodiments of the invention the difference between engines speeds nmax 50% and nmax75% is larger than 200 or even larger than 250 rpm.

In another embodiment the speed nmax50% is less than 2000 rpm or even less than 1900 rpm. In a further embodiment the engine rotational speed nmax50% is less than 2300 rpm.

In alternative embodiment of the invention the maximum engine rotational speed at 50% of maximum engine power (nmax50%) should be larger than 1.2 multiplied by the maximum engine rotational speed at 95% of maximum engine power (nmax95%). In a further embodiment the maximum engine rotational speed at 50% of maximum engine power (nmax50%) should be larger than 1.3 multiplied by the maximum engine rotational speed at 95% of maximum engine power (nmax95%).

In another embodiment of the invention the maximum engine speed at maximum allowable engine rotational speed, n4 (see FIG. 2), is kept high; where the difference between engine rotational speeds n4 and nmax50% is larger than 100 rpm. In further embodiments of the invention said difference can be larger than 125 rpm or even larger than 150 rpm. That improves the driveability at low load with minimal impact on the engine efficiency.

Another embodiment of the invention addresses potential unfamiliar feelings of the operator due to the rapid change of maximum engine speed above half maximum power. With a power-interrupting automatic transmission, that can be avoided by appropriate gear selection. The invention is thus very useful for automatic mechanical transmissions (AMT) or semiautomatic transmissions where the gear selection and the carrying out thereof are performed automatically. This is due, to that in powertrains equipped with a power-interrupting automatic transmission a control unit registers current engaged gear ratio and planned coming gear ratio that will be engage. Thus, the potential of using all the benefits of the invention are greater in a powertrain where gearshifting points can be controlled by the system. The benefits of the invention are also useful when the engine is mated to a dual clutch transmission (DCT).

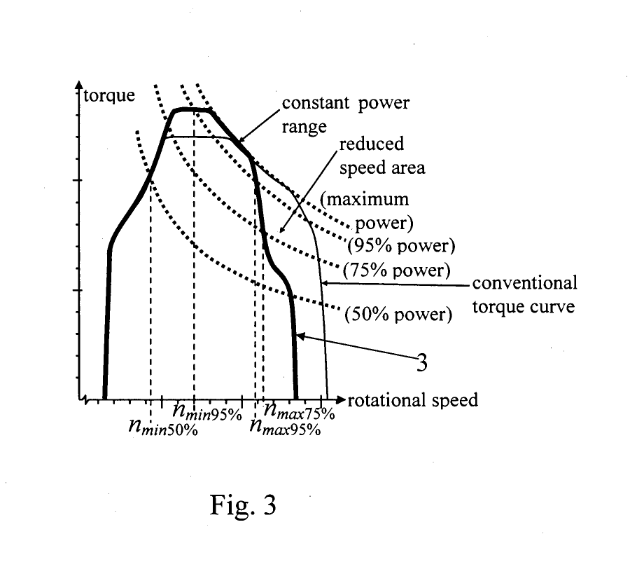

In another embodiment of the invention disclosed in FIG. 3 the torque is ramped down steeply from the constant power range. This can be quantified as having a difference between the maximum speeds at 75% and 95% of maximum engine power (nmax75%−nmax95%) less than 150 rpm. In further embodiments said speed difference (nmax75%−nmax95%) can be less than 125 rpm or even less than 100 rpm.

In a further embodiment the constant torque range has been reduced and the maximum torque of the engine has been increased, as shown in FIG. 3 (compare thick line with thin line). Thereby, it has been possible to move the entire torque ramp down towards lower engine speed. That gives an additional potential to optimise the engine towards improved efficiency. The constant power range has been kept large enough to maintain the vehicle performance when high engine power is required. In all, this can be quantified as follows;
nmax95% being less than 1600 rpm or less than 1500 rpm or even less than 1400 rpm, and
the ratio of the maximum and minimum engine speeds at 95% of maximum engine power (nmax95%/nmin95%) being larger than 1.25 or larger than 1.3 or even larger than 1.35.

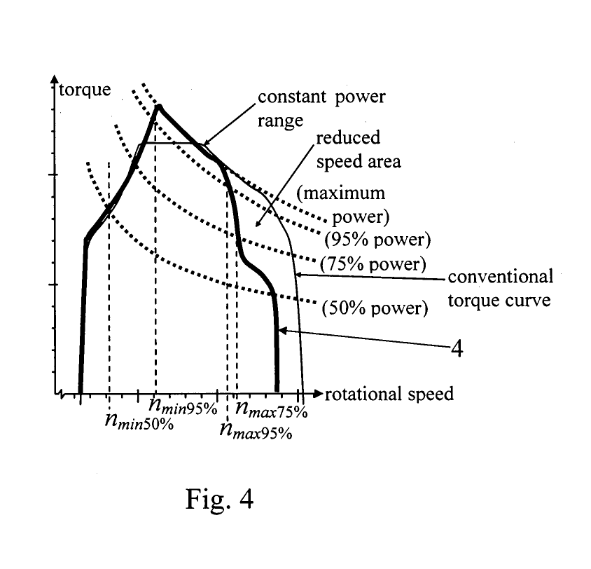

In connection to the embodiment of FIG. 3 another embodiment would be that the constant torque range can be reduced to zero and the maximum torque of the engine can be increased even further, as shown in FIG. 4 (compare thick curve 4 with thin line). Thus, the invention is in FIG. 4 applied in a so called constant power engine (see curve 4).

The last requirement corresponds to the ratio steps (i.e., the ratio between the gear ratios of two consecutive gears, e.g., the gear ratios of gears 4 and 5) in most power-interrupting transmissions for heavy road vehicles. Those ratio steps are, in general, between 1.15 and 1.35.

The realization of the different embodiments of the invention can be done in several different ways. One can start from a conventional engine and reconfigure the engine in order to work according to the invention, for example by reprogramming controlling programs of the powertrain (engine control unit and transmission control unit). One can also develop an engine from the start to work according to the invention. This can be done by adapting several components in the powertrain, such as supercharging arrangements (for efficiency when allowing a more narrow operating range), engine cooling system etc, where the result of all the different adaptations will be a curve according to the invention. Said supercharging arrangement can be designed to work for example within a substantively narrower working range compared to conventional supercharging arrangements. One can adapt a supercharger that functions well (gives high torque and/or high efficiency) at low engine rotational speeds, but that is not capable to produce at or near maximum engine power at high engine rotational speeds. At low engine power and high engine rotational speeds the supercharger will be capable to produce its best performance, which is shown in said FIGS. 2, 3 and 4.

The engine can be controlled according to said inventive embodiments for engine rotational speed and torque. The control as such not to exceed set limits for different combinations of rotational engine speeds and torques is performed in a known way.

The invention is of advantage especially for single-stage supercharged combustion engines. The invention can also be used in for example combustion engine of the turbo-compound type.

Mentioned power-interrupting transmission can be an Automated Mechanical Transmission (AMT).

FIG. 4 shows an apparatus 500 according to one embodiment of the invention, comprising a nonvolatile memory 520, a processor 510 and a read and write memory 560. The memory 520 has a first memory part 530, in which a computer program for controlling the apparatus 500 is stored. The computer program in the memory part 530 for controlling the apparatus 500 can be an operating system.

The apparatus 500 can be enclosed in, for example, a control unit, such as said combustion engine control unit. The data-processing unit 510 can comprise, for example, a microcomputer.

The memory 520 also has a second memory part 540, in which a program for controlling engine rotational speed and torque according to the invention is stored. In an alternative embodiment, said program for controlling engine rotational speed and torque is stored in a separate nonvolatile data storage medium 550, such as, for example, a CD or an exchangeable semiconductor memory. The program can be stored in an executable form or in a compressed state.

When it is stated below that the data-processing unit 510 runs a specific function, it should be clear that the data-processing unit 510 is running a specific part of the program stored in the memory 540 or a specific part of the program stored in the nonvolatile recording medium 550.

The data-processing unit 510 is tailored for communication with the memory 550 through a data bus 514. The data-processing unit 510 is also tailored for communication with the memory 520 through a data bus 512. In addition, the data-processing unit 510 is tailored for communication with the memory 560 through a data bus 511. The data-processing unit 510 is also tailored for communication with a data port 590 by the use of a data bus 515.

The method according to the present invention can be executed by the data-processing unit 510, by the data-processing unit 510 running the program stored in the memory 540 or the program stored in the nonvolatile recording medium 550.

The invention should not be deemed to be limited to the embodiments described above, but rather a number of further variants and modifications are conceivable within the scope of the following patent claims.

1. A combustion engine control unit arranged to control output torque and engine rotational speed so as to never exceed a curve of maximum allowable engine torque as a function of engine rotational speed for controlling a combustion engine, where the curve is defined by at least a torque build up range (n0 to n1), constant power range (n2 to n3) and a torque ramp down range (n3 to n4), wherein the torque ramp down range is defined so that the engine rotational speed at high engine power is reduced, while high engine rotational speeds are allowed at low engine power, and where one or more components in a powertrain of which the engine is a part are adapted in order to provide the curve.

2. A control unit as in claim 1, wherein high engine power is defined as above 50% of the maximum engine power and low engine power is defined as below 50% of the maximum engine power.

3. A control unit as in claim 1, wherein a difference between maximum engine rotational speeds at 50% and 75% of maximum engine power is larger than 150 rpm.

4. A control unit as in claim 3, wherein the maximum engine rotational speed at 50% of maximum engine power (nmax50%) is less than 2300 rpm.

5. A control unit as in claim 1, wherein the maximum engine rotational speed at 50% of maximum engine power (nmax50%) is larger than 1.2 multiplied by the maximum engine rotational speed at 95% of maximum engine power (nmax95%).

6. A control unit as in claim 4, wherein at maximum allowable engine rotational speed (n4) and 0% of maximum engine p01.,er the difference between the maximum allowable engine rotational speed and engine rotational speed at 50% of maximum engine power (nmax50%) is larger than 100 rpm.

7. A control unit as in claim 1, wherein the combustion engine is mated to a power-interrupting automatic transmission.

8. A control unit as in claim 1, wherein the combustion engine comprises a supercharging arrangement of the turbocompound-type.
